(19) United States
(12) Patent Application Publication
(10) Pub. No.: US 2026/0338527 A1
(43) Pub. Date: Oct. 29, 2026

(54) Sliding Thread Pitch Gauge for Fastener Identification

(71) Applicant: Kevin Lloyd Durette, Portland, OR (US)

(72) Inventor: Kevin Lloyd Durette, Portland, OR (US)

(21) Appl. No.: 19/658,627

(22) Filed: Apr. 26, 2026

Related U.S. Application Data
(60) Provisional application No. 63/795,550, filed on Apr. 27, 2025.

(51) Int. Cl. G01B 3/40

(52) U.S. Cl. CPC G01B 3/40

(57) ABSTRACT

A thread pitch gauge includes a flat base having plural sets of periodic indentations that accommodate the side of the threads of a threaded fastener. Each set corresponds to a standard thread pitch. Sliding a threaded fastener transversely across the sets causes the fastener to drop into the matching set, providing tactile and visual feedback to identify thread pitch. Each set is labeled and has a length proportional to its pitch, with metric and imperial interspersed. The sets are arranged in order of pitch size, defining a tapered boundary.

This application claims the benefit of U.S. Provisional Application No. 63/795,550, filed Apr. 27, 2025, the entirety of which is incorporated herein by reference.

### FIELD

The present disclosure relates to a gauge for quickly identifying the thread pitch of an unknown fastener.

### BACKGROUND

The identification of an unknown fastener may be required for correct inventory put-away, reverse engineering, or maintenance or repair. Among the most important variables in this identification are the nominal diameter and the thread pitch. Gauges that simultaneously measure both diameter and thread pitch are popular among casual users, as disclosed in U.S. Pat. Nos. 2,528,431A, 2,728,145A, 3,218,724A, 5,131,162A, USD454509S1, and 7,877,882B2; however, the requirement to provide measurement capability for each combination of diameters and thread pitches results in a multiplicative increase in the number of required configurations, thereby constraining such gauges to only the most commonly used sizes. Professional users therefore often take two separate measurements for diameter and thread pitch, with the latter usually performed using a Starrett-type gauge as described in U.S. Pat. No. 318,051A.

The order in which measurements of thread pitch and diameter are taken can affect both speed and accuracy. Conventionally, a threaded fastener's thread pitch measurement system matches its nominal diameter system: inches-based diameters use threads per inch, while metric diameters use millimeters per thread. Digital calipers enable a fast diameter measurement, whereas commodity handheld thread pitch gauges require the operator to manipulate several moving parts and are typically segregated by measurement system (metric or imperial), so the common practice is to measure diameter first. However, close metric and imperial diameters can be easily confused; for example, 27 mm is only 0.0125 mm or 0.00049 inches larger than 1 1/16 inch. In such cases, identifying the thread pitch first can disambiguate close potential matches and inform the operator which measurement system to apply for the diameter. Thus, a gauge that enables faster measurement of thread pitch could advantageously reverse the conventional measurement order.

Starrett-type gauges require the operator to individually select and apply separate pivoting blades, one at a time, and are typically sold as separate metric and imperial sets, requiring advance knowledge of the fastener's measurement system. A gauge with no moving parts would reduce operator manipulation, and a gauge with no measurement-system segregation would eliminate the requirement to know the fastener's system in advance.

### SUMMARY

A thread pitch gauge for identifying the thread pitch of an unknown fastener is disclosed. The gauge consists of a base with indentations that accommodate the threads of the side of a threaded fastener, with one set of indentations for each possible thread pitch. It is operated by sliding the long side of the fastener on the surface of the base until the fastener threads and gauge threads interlock, settling down into the surface to give the operator both visual and tactile feedback that the labeled thread size on the gauge corresponds to that of the fastener. This one-piece gauge with no moving parts requires minimal operator manipulation.

### BRIEF DESCRIPTION OF THE DRAWINGS

FIG. 1 is an isometric view of an example embodiment of the gauge.

FIG. 2 shows a cutaway view of the gauge and an operator placing a threaded fastener in an incorrect position on the gauge for the fastener's thread pitch.

FIG. 3 shows a cross section cutaway of the gauge and an operator placing a threaded fastener in the correct position on the gauge for the fastener's thread pitch.

FIG. 4 shows a perspective cutaway view of the gauge and a matching threaded fastener placed upon it.

### DETAILED DESCRIPTION

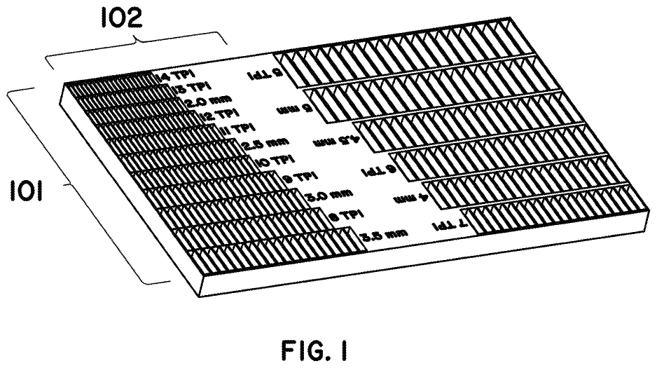

An embodiment of the thread gauge is illustrated in FIG. 1. The gauge is flat, and on the top are multiple sets of thread-accommodating indentations, one set with a periodic profile for each of the thread pitch sizes covered by the gauge. Each set within a group starts from a common edge of the gauge 101. Each set of indentations represents one standard thread pitch size, the indentations for which are wide enough to allow a threaded fastener of the largest standard diameter for that particular thread pitch to settle into it and provide positive locking feedback to the operator when the correct thread pitch has been identified.

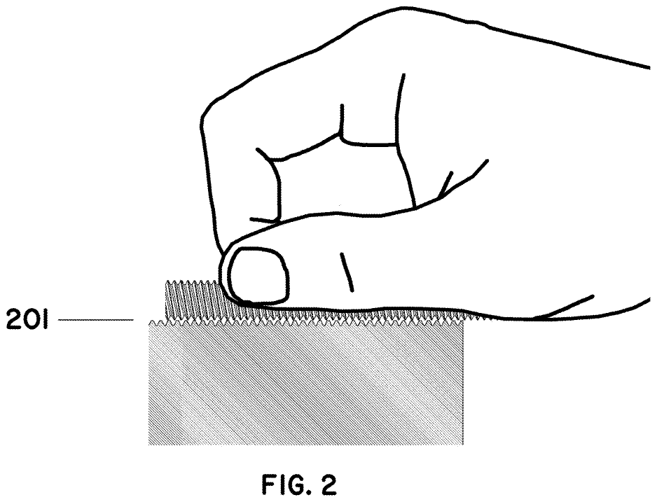

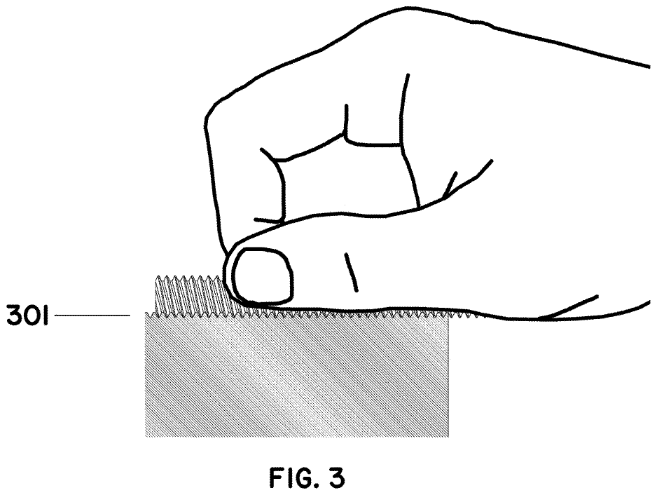

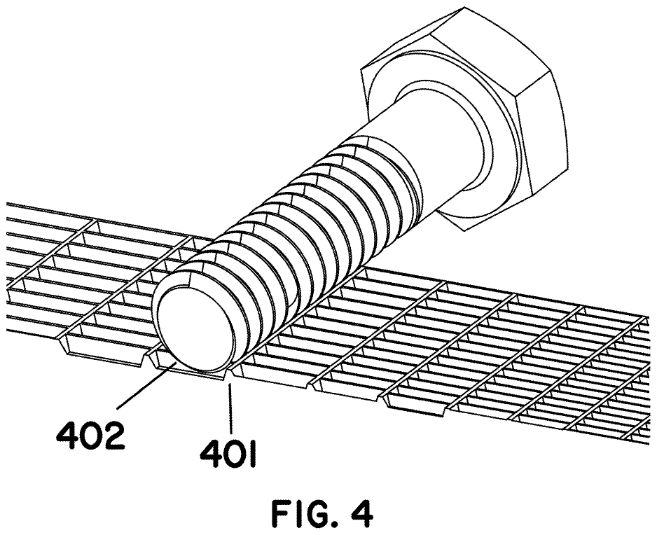

To use the gauge, the operator first places an unknown fastener flat against the top of the gauge. The fastener's head, if it has one, hangs off the common edge 101 to allow a representative number of threads to make contact. Starting from either end 102 of the gauge, the operator slides the fastener in one smooth motion over each set of indentations, parallel to edge 101, preferably as a translation without rotation. Throughout most of this operation, the fastener's threads will not match the gauge's indentations, and the operator will encounter the condition shown in FIG. 2; the fastener remains elevated to the plane of the gauge by the threads interfering with the gauge, with the stability of this condition maintained by the mismatch interference of the two pitch sizes 201. Without vertical travel, the fastener will continue to traverse with no resistance apart from friction, usually traversing multiple sets prior to engagement. When the fastener encounters the correct, matching set of indentations corresponding to its thread pitch, as shown in FIG. 3, the fastener settles into the gauge due to the alignment of the two pitch sizes 301 and engages by partial seating. The operator receives tactile and visual feedback of this downward motion and feels resistance to continued lateral motion. As shown in FIG. 4, this resistance is developed by the interference of the side corners 401 of the indentations against the major surface of the threaded fastener. The longitudinal axis of the fastener remains orthogonal to the gauge's edge 101 throughout the operation. The operator reads the thread pitch of the indentation set where the fastener stopped to ascertain the thread pitch of the fastener.

If the thread pitch size is very close but not perfectly correct, the fastener may see-saw without settling flat. Some operator skill may be required to recognize and identify this condition. For example, a thread pitch of 0.75 mm is only about 0.4% larger than 34 TPI.

Because each indentation set accommodating n threads of pitch length P defines an indentation set length of nP, sets for coarser pitches necessarily occupy greater longitudinal distance. When arranged sequentially by pitch, the resulting collection of sets forms a trapezoidal or tapered footprint.

In one embodiment, the two sides of the gauge provide two common edges 101, splitting the range of covered thread pitches across the two sides to maximize the efficient use of rectangular space, leaving only a thin, diagonally oriented space between them. For further refinement, both sides of the gauge may contain such indentations to extend the range of available thread pitches, both toward and away from the viewer in FIG. 1, providing a total of four common edges 101.

In environments where both metric and imperial fasteners are encountered, a thread gauge operator may not know in advance whether a fastener is metric-sized or inch-sized, so in some embodiments, the indentation sets are arranged along the surface in order of increasing pitch length, such that adjacent pitch elements correspond to successive pitch lengths independent of measurement system origin. This allows the operator to use the gauge exactly once without advance knowledge of the measurement system of the fastener. Because the gauge is a one-piece tool with no moving parts, this sequencing is permanent and not user-alterable.

In the embodiment of FIG. 1, each indentation set extends a length sufficient to accommodate twenty threads of the corresponding pitch. For a 1.0 mm pitch (25.4 TPI), the set length is 20.0 mm (0.787 inches); for 20 TPI (1.27 mm pitch), the length is 1 inch (25.4 mm). While as few as five indentations are sufficient for the gauge to function, a greater number of indentations increases the likelihood of engagement and reduces the operator skill required to discern the correct pitch.

The gauge may be manufactured from any suitable material using any suitable technique. The base may be formed from injection-molded ABS, molded PE, machined aluminum, or 3D-printed PLA, without departing from the scope. Given the complexity of the geometry necessary to design and make a gauge supporting several thread pitches while also optimizing costs and space, one embodiment relies on automated, low-volume manufacturing, such as additive manufacturing.

The exact shape of one indentation that accommodates one thread is not critical, since the usefulness of the gauge is provided by the harmony of the indentation pitch and fastener pitch and not by perfect engagement. It may be observed, for example, that a right handed fastener and a left handed fastener would require different configurations to achieve total thread-envelope matching, and the diameter of the bolt would affect the necessary angle. The goal, rather, is to achieve engagement that is merely good enough for discernment, producing acceptance or rejection of the fastener against the gauge. In one embodiment, the geometry is mirrored from the diametral cross section of a standard bolt of that thread pitch, without regard for the helical twist of the fastener, using rectangular cutouts with walls sloping thirty degrees from vertical or sixty degrees wall to wall. With subtractive manufacturing, for example, this shape is achievable with a v-groove routing bit. The gap between indentations, in the direction parallel to the bolt axis, is one quarter of the thread pitch, and the floor of the indentation is one eighth of the thread pitch in length. The depth of the indentation is five eighths the thread pitch. In the other direction, radial to the bolt and lateral to the gauge surface, the indentation is wide enough to engage a fastener of the maximum standard diameter for that pitch. In the shown embodiment, this width is four times the thread pitch plus a small constant additional width of 0.5 mm to accommodate declining user precision at smaller sizes. In the plane normal to the fastener axis, any indentation shape that achieves the required interference 401 and is sufficiently deep to accommodate the difference between the major and minor radii of the fastener 402 will achieve the required function.

This gauge measures the thread pitch of a bolt, screw, or any cylindrical male threaded fastener manufactured with non-self-tapping threads per any standard, common, or otherwise discoverable thread pitch size.

1. A thread pitch gauge comprising:
a base having a continuous surface;
a plurality of indentation sets formed in the surface of the base, each indentation set comprising a linear array of adjacent, periodic indentations arranged along a first direction;
wherein the base is unitary or composed of rigidly affixed components;
wherein the plurality of indentation sets are exposed on the continuous surface;
wherein each indentation set defines a repeating profile having a predetermined pitch and flank geometry corresponding to a threaded fastener standard;
wherein the plurality of indentation sets have different respective pitches;
wherein the plurality of indentation sets are arranged adjacent to one another along a second direction transverse to the first direction, such that a threaded fastener translated across the surface substantially remains in contact with successive indentation sets;
wherein each indentation set extends in the first direction substantially parallel to a longitudinal axis of a threaded fastener when the fastener is positioned on the surface;
wherein the indentation sets are arranged contiguously along the second direction, the indentation sets being uninterrupted by structures that prevent lateral traversal of a fastener across successive sets; and
wherein each indentation set is labeled.

2. The thread pitch gauge of claim 1,
wherein the indentation sets are arranged in a single monotonic sequence including both metric and imperial pitches interleaved.

3. The thread pitch gauge of claim 1,
wherein the base is flat.

4. The thread pitch gauge of claim 1,
wherein each indentation has a depth of at least half the difference between the major and minor radii of a corresponding threaded fastener such that partial radial engagement is geometrically permitted.

5. The thread pitch gauge of claim 1,
wherein each indentation set has a longitudinal length that increases with increasing thread pitch, and
wherein the indentation sets are positioned adjacent to one another in order of pitch size along the second direction, such that the plurality of indentation sets define a boundary having a tapered shape.

6. The thread pitch gauge of claim 5,
wherein the base has a rectangular outline and contains two such tapered arrangements of thread-accommodating indentations with a narrow, diagonally oriented space between them.

7. The thread pitch gauge of claim 6,
wherein the base is substantially flat and contains four such tapered arrangements as a result of applying two tapered arrangements to each of the two sides of the base.

8. The thread pitch gauge of claim 1,
wherein the indentations have walls between 25 and 35 degrees from vertical.

9. The thread pitch gauge of claim 1,
wherein each indentation set accommodates at least five fastener threads.

10. The thread pitch gauge of claim 1,
wherein the indentation sets are arranged parallel to an edge of the gauge, providing space for the fastener's head to hang off the side and enabling the fastener to translate without losing flat contact with the gauge.

11. The thread pitch gauge of claim 1,
wherein each indentation has a rectangular shape at the plane of the surface.

12. The thread pitch gauge of claim 1,
wherein each indentation of a set has a depth 0.5 to 0.75 times the thread pitch, a floor length in the first direction between one sixteenth and one quarter of the thread pitch, and a gap between adjacent indentations between one eighth and half the thread pitch.

13. A thread pitch gauge comprising:
a plurality of indentation sets formed in a surface, each corresponding to a thread pitch;
wherein the plurality of indentation sets includes sets corresponding to at least one metric pitch and at least one imperial pitch;
and wherein the indentation sets are physically arranged along a direction on the surface in a single monotonic sequence of pitch values independent of measurement system.

14. A method for identifying the thread pitch of a fastener, comprising:
sliding the fastener across a contiguous sequence of indentation sets arranged such that non-matching sets maintain the fastener in an elevated interference condition and a matching set permits vertical displacement;
and identifying the thread pitch based on the indentation set at which the vertical displacement occurs.

15. The method of claim 14, wherein the surface is flat and forms part of a gauge having no moving components.
